(19) United States
(12) Patent Application Publication
(10) Pub. No.: US 2007/0233759 A1
(43) Pub. Date: Oct. 4, 2007

(54) Platform for seamless multi-device interactive digital content

(75) Inventors: William M. Tomlinson, Irvine, CA (US); Man Lok Yau, Alhambra, CA (US)

Correspondence Address: SHIMOKAJI & ASSOCIATES, P.C., 8911 RESEARCH DRIVE, IRVINE, CA, 92618, US

(73) Assignee: The Regents of the University of California

(21) Appl. No.: 11/392,285

(22) Filed: Mar. 28, 2006

(51) Int. Cl. G06F 15/00

(52) U.S. Cl. 708/200

(57) ABSTRACT

A multimedia information system includes multiple devices and provides automatic transfer of content between devices when any two of the devices are collocated, i.e., brought within a physical proximity and relative orientation of each other that allows each to detect the other, for example, using infrared data devices. The multimedia, multi-device information system provides a seamless information space between the devices once they are within an appropriate proximity and relative orientation and operates across multiple devices—such as desktop computers, tablet PCs, PDAs and cell phones. Animation of the content transfer provides interactivity and user engagement with the system.

### BACKGROUND OF THE INVENTION

The present invention generally relates to multimedia information systems and, more particularly, to a platform for interactive digital content, such as interactive graphics and sound, that operates seamlessly across multiple collocated computational devices.

Over the past several decades, computational devices have spread rapidly among many human societies. These devices are now sufficiently common that some people have more than one of them, for example owning a workstation, a personal computer (PC), a notebook computer, a PDA (personal digital assistant), and a mobile phone. These devices are often networked to each other and to the Internet, together providing the platform for an individual's personal information space. However, the varied interaction paradigms that we use when engaging these devices do not always facilitate a coherent experience across multiple devices. In order for these devices to integrate smoothly together and for people to understand their cooperation, new interaction paradigms are needed.

In prior art systems, the triggering of content (e.g., opening a file and transferring data) is done manually by people. For example, a person would need to decide which content should be opened on a given device. In prior art systems, the problem of how to transfer data between devices is solved through a time-consuming process of explicitly moving data and computational objects between devices using floppy disks, external hard drives, Ethernet cables, and similar technologies. For example, to move data from one device to another using a USB flash-memory storage device typically requires several steps—inserting the storage device, opening a window for the directory containing the file to be transferred, opening a window for the storage device, dragging the file from one window to another, waiting for the file transfer to complete, ejecting the storage device, physically carrying it to another device, and repeating the above steps. This process could take a minute or more of time, and requires a significant degree of user attention throughout most of that time. While certain processes, such as synchronizing a PDA, have attempted to streamline this process, there is still significant delay to the transfer. Synchronizing may occur with one click, but the PDA may then be non-functional for several seconds or longer while the process completes, so that the process is inefficient to the user. Even if the devices between which data is to be transferred are widely separated yet connected by a network, such as the Internet, there is still a similar burden on the user as to deciding which content is to be transferred, specifying the origin and destination for the transfer, and so on, that requires the user to perform a number of steps similar to the above and which may be time consuming as well, so that having the devices near each other offers no advantage, as far as content transfer and transparency to the user is concerned, over devices that may be, e.g., hundreds or thousands of miles apart from each other. In other words, prior art techniques do not take optimal advantage of physical collocation of devices by using the relative orientation of the devices, which is not readily available to widely separated devices. . . .

These prior art methods for triggering and transferring content do not create a seamless (e.g., able to operate transparently to the user across multiple devices—such as desktop computers, tablet PCs, PDAs and mobile phones) and efficient cross-device experience among collocated devices (e.g., devices within a direct line of sight of each other or within some relatively small distance, such as a few feet of each other and arranged in some particular orientation with respect to each other). In addition, by not taking full advantage of physical proximity and relative orientation of devices, prior art systems ignore features needed for enhanced information transfer. In order for multi-device systems to reach their full potential as powerful tools for work, learning and play, a seamless and efficient multi-device experience is needed.

As can be seen, there is a need for automatic (as opposed to manual, as described above) triggering of content when devices are placed in a certain physical relationship (e.g., proximal and oriented) and for seamless transfer of content between devices. There is also a need to provide multi-device operation responsive to the devices being placed in a certain physical relationship. Moreover, there is a need for multi-device systems that enhance opportunity for collaboration and communication between people by connecting the multiple types of devices that they carry and multi-device systems that provide an analogy between the real world and the virtual world that enhances information transfer.

### SUMMARY OF THE INVENTION

In one embodiment of the present invention, a multimedia information system includes a first computational device and a second computational device. Information content is automatically transferred between the second computational device and the first computational device when the first computational device and the second computational device are collocated.

In another embodiment of the present invention, a multi-device system includes: a first device having a first detector and a second device having a second detector. The second detector detects a first presence and a first orientation of the first device, and the first detector detects a second presence and a second orientation of the second device. The system also includes an agent that receives communications from the first detector and the second detector and decides whether or not to transfer between the first device and the second device on a basis that includes the communications from the first detector and the second detector.

In still another embodiment of the present invention, a system includes at least two computational devices each having a networking system and an embodied mobile agent that includes a graphically animated, autonomous software system that migrates seamlessly from a first computational device to a second computational device and that is executing on at least one of the devices. At least one of the devices includes a global decision system which communicates with an adjacent virtual environment of a collocated device via a networking system, communicates with the embodied mobile agent, and causes an animation engine to display a characteristic that reflects a presence and characteristic of the adjacent virtual environment. The agent communicates with the animation engine so that the animation engine display reflects where the agent is and what the agent is doing.

In yet another embodiment of the present invention, a multimedia information system includes a first computational device; and a second computational device that includes: a detector that detects a presence and orientation of the first computational device; a sensor that senses an aspect of the physical environment of the second computational device; a networking system that receives information of the presence and orientation of the first computational device from the detector and communicates with the first computational device; an embodied mobile agent that modifies and communicates an information content; and a global decision system. The global decision system: communicates with the networking system; communicates with the embodied mobile agent; communicates with the sensor; and provides an output based on input from the networking system, the agent, and the sensor. The information content is transferred between the second computational device and the first computational device in accordance with a decision made by the embodied mobile agent that includes utilizing the information of the presence and orientation of the first computational device and utilizing the global decision system communication with the agent. The system also includes an animation and sound engine that receives the information content from the embodied mobile agent, receives the output from the global decision system, and provides animation and sounds for the embodied mobile agent to a display of the second computational device that utilizes the aspect of the physical environment of the second computational device, and the information of the presence and orientation of the first computational device to cause the animation and sounds to appear to be continuous between the first computational device and the second computational device.

In a further embodiment of the present invention, a computational system includes a first computational device; a virtual character residing on the first computational device; and a second computational device, in which the virtual character automatically transfers from the first computational device to the second computational device when the second computational device is collocated with the first computational device.

In a still further embodiment of the present invention, a method for automatic data transfer between computational devices, includes the steps of: collocating at least two distinct computational devices; making an autonomous decision for an interaction to occur between the two collocated computational devices; and performing the interaction automatically between the two collocated computational devices.

In yet a further embodiment of the present invention, a method for multi-device computing includes steps of: displaying a first animation on a first computational device; bringing a second computational device into a physical proximity and relative orientation with the first computational device; and displaying a second animation on the second computational device, in which the second animation is synchronized with the first animation and the second animation is spatially consistent with the first animation.

In an additional embodiment of the present invention, a method of creating a continuous graphical space includes steps of: detecting a proximity and relative orientation between at least two computational devices; storing information of the proximity and relative orientation in each of the two computational devices; and communicating between the two computational devices to create the continuous graphical space.

These and other features, aspects and advantages of the present invention will become better understood with reference to the following drawings, description and claims.

### BRIEF DESCRIPTION OF THE DRAWINGS

FIG. 1 is an illustration showing a multimedia information system according to one embodiment of the present invention and system users interacting with the system;

FIG. 2 is an illustration showing two communicating devices of the multimedia information system of FIG. 1 and exemplary animations in accordance with one embodiment of the present invention;

FIG. 3 is a block diagram depicting the two communicating devices of FIG. 2;

FIG. 4 is a detailed view of the block diagram of FIG. 3, showing an exemplary configuration for a virtual environment module; and

FIG. 5 is a flowchart of a method for operating a platform for transferring interactive digital content across multiple collocated computational devices in accordance with one embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides for transfer of interactive digital content—such as interactive graphics and sound—that operates seamlessly across multiple collocated computational devices, i.e., devices arranged within some pre-determined proximity to each and within some pre-determined range of relative orientations to each other. The invention involves apparatus and methods for transferring content among stationary and mobile devices, automatically triggering the transference of content among devices, and creating a coherent user experience (e.g., in which the multiple devices operate similarly enough to each other and with displays well enough synchronized to appear as parts of a whole) across multiple collocated devices. As an example of multiple devices operating similarly enough to each other to create a coherent user experience, it may be that the level of detail of the graphical effects needs to be balanced to maintain the frame rate of one of the devices. For example, between a desktop computer and a mobile device, since the graphical capabilities of the mobile device do not match those of the desktop computer, the amount of detail of an animation displayed on the mobile device may be reduced to maintain an acceptable frame rate of animation on the mobile device. For example, the invention may involve the coordination (e.g., synchronization of animations occurring on distinct devices) of digital content on each device, the sensing of the proximity and orientation of devices to each other, the communication among devices, the synchronization of devices so that content can appear to move seamlessly from one to the other, and deployment of autonomous computational agents that operate on devices in the system. By combining real-time graphics, inter-device sensing and communication, and autonomous computational agents, the invention can achieve a seamless functioning among devices, and efficient coordination of multiple devices that contribute to transparency to the user, for example, by unburdening the user from performing details of the multi-device interaction.

A principle of the present invention is that the coordination of collocated devices to produce a multi-device system can yield superior functionality to the constituent devices operating independently. The invention may enable graphics, sound, autonomous computational agents, and other forms of content to appear to occupy a continuous virtual space across several different devices, thereby reducing time delays in the interoperation of devices and enabling new kinds of interactions that are not possible without the explicit and seamless content transfer between devices provided by the present invention.

A “continuous graphical space” may refer to a graphical space, as known in the art, in which sharing of graphics information among devices is done in a way that allows those devices to produce graphics displays that are consistent with each other. Thus graphical continuity may be used to refer to multi-device operation of a system in which distinct animations on multiple devices—also referred to as “cross-device” animations—appear synchronized and smoothly performed in real time and in which the distinct animations of the cross-device animation appear to maintain spatial consistency between the relative orientations of the animations occurring on the device displays and the device displays themselves. More simply put, in a continuous graphical space, the distinct animations on distinct devices may appear physically consistent, both temporally and spatially, with each other as displayed on multiple collocated displays and may use the physical relationship (e.g., proximity and relative orientation) between the devices to give the appearance of physical continuity between the two animations so that the two animations appear as a single animation occurring across the devices.

By enabling users to have seamless interactions with multiple computational devices, the present invention enables new forms of system applications, such as entertainment (e.g., collocated multi-device computer games), education (e.g., interactive museum exhibits), commercial media (e.g., trade show exhibits) and industrial applications (e.g., factory simulation and automation). The invention has applicability to any context in which two or more devices, at least one of which is mobile, occupy a physical space in which they may be brought within some pre-determined proximity and relative orientation to each other.

For example, the present invention has applicability in multi-device industrial applications, in which there are numerous applications for the present invention's taking account of the physical locations and orientations of devices to trigger virtual content that could increase the efficiency of industrial processes. By enabling content to occur automatically on mobile devices when they enter a trigger zone, for example, an individual walking through a factory could have the manuals for each machine spontaneously appear on her PDA as she approached one machine and then another machine.

Also, for example, the present invention has applicability in multi-device simulation, in which a challenge with complex interactive simulations is providing users the ability to interact with and influence the simulations in an intuitive and effective way. Multi-device systems that take collocation of devices into account in the manner of embodiments of the present invention can provide a novel type of interaction between people and multi-device simulations.

For example, a computer simulation for restoration ecology may include embodied mobile agents in the form of animated animal and plant species. The simulation may include three stationary computers to represent virtual islands, and three mobile devices to represent rafts or collecting boxes. Each virtual island may represent a different ecosystem. The ecosystems can be populated with hummingbirds, coral trees, and heliconia flowers. Users can use the mobile devices to transport species from one island to another by bringing a mobile device near one of the stationary computers. One of the virtual islands may represent a national forest, which has a fully populated ecosystem and can act as the reserve, while the other two virtual islands can be deforested by the press of a button from one of the users. Users can repopulate a deforested island by bringing different species in the right order to the island by means of the mobile devices.

Additionally, for example, the present invention has applicability for a museum exhibit in which the invention has been used to develop a multi-device, collaborative, interactive simulation of the process of restoration ecology as described above. By creating a collaborative experience that connects the real world with a virtual world, this museum exhibit has helped people connect the topics they learned in the simulation to potential application in the real world. Similarly, for example, the present invention has applicability for trade-show exhibits, in that just as the invention can be used to develop educational exhibits around academic topics, it may also be used to develop exhibits that inform people about the qualities of various commercial products.

As a further example, the present invention has applicability to collocated multi-device gaming. As computational devices spread through human societies, the increasing number of opportunities for these devices to work together for entertainment applications has created a push toward physicality in games, with various companies putting forward physical interfaces to games such as dance pads and virtual fishing poles, and other companies offering games that encourage children to exercise during grade school physical education class so that the present invention can extend this physicality by creating the possibility for games that stretch across multiple collocated devices and take advantage of the unique opportunities offered by collocation.

In one aspect, the present invention differs, for example, from the prior art—in which the triggering of content (e.g., opening a file and transferring data) was done manually by people (e.g., a person would need to decide which content should be opened on a given device)—by allowing the triggering of content to be done automatically when a device is brought into a certain physical (e.g., proximity and orientation) relationship with another device, whether or not the person carrying the device is aware of the fact that the physical relationship between devices will have that effect. While prior art systems such as the “EZ-PASS” highway toll mechanism utilize proximity and orientation/line-of-sight to make data transfers, such a prior art system does not utilize this proximity and orientation/line-of-sight to create the appearance of a continuous graphical space across multiple computational devices as created by embodiments of the present invention.

In further contrast to the prior art in which users needed to mouse click on the specific data item and drag it or use some other input device such as a pen, wand, or trackball to act on the specific data item, an embodiment of the present invention may create a simplified user experience across multiple devices in which simply moving a device into an appropriate trigger area transfers the data item without the user needing to be aware of the specific data item being transferred in order to create seamless operation across the multiple devices and make the multi-device system easier to use and, therefore, more enjoyable.

A problem solved by one aspect of the invention is that prior art mechanisms for connecting two or more devices in the same physical space (e.g., within direct line of sight of each other) were cumbersome, as in the example of using a USB flash-memory device given in the background section above, and offered little advantage over connecting two devices which might be widely separated yet connected, for example, by a network such as the Internet. The present invention offers, in contrast to the prior art, at least two aspects of a solution to that problem. The first aspect is the automatic triggering of content when a device enters a certain range of proximity and orientation to another device. The second aspect is having a seamless information space (e.g., virtual world or virtual space) between the two devices once they are within the appropriate proximity and orientation.

More specifically, an aspect of the present invention differs from the work of McIntyre, A., Steels, L. and Kaplan, F., “Net-mobile embodied agents.” in Proceedings of Sony Research Forum, (1999), in which agents move from device to device via the Internet—so that there need not be any proximal physical relationship between the devices—in that the embodiment of the present invention enables autonomous computational agents to move between collocated devices in a way that utilizes the physical relationship (e.g., proximity and relative orientation) between the devices to automate the transfer and make the transfer more believable. For example, for a device A to the left of a device B, a character should exit A to the right and appear on B from the left. A character that exited A to the left and appeared on B from the right, i.e., the “wrong direction”, for example, would be less believable and possibly not comprehensible. Thus, a multi-device system according to an embodiment of the present invention may provide a continuous graphical space among multiple collocated devices that prior art systems do not provide.

Another aspect of the present invention differs from the work of Rekimoto, J., “Pick-and-drop: a direct manipulation technique for multiple computer environments.” in UIST '97: Proceedings of the 10th annual ACM symposium on User interface software and technology, ACM Press, 1997, 31-39, or of Borovoy, R., Martin, F., Vemuri, S., Resnick, M., Silverman, B. and Hancock, C., “Meme tags and community mirrors: moving from conferences to collaboration.” in Proceedings of the 1998 ACM conference on Computer supported cooperative work, (1998), ACM Press, 159-168 in that an embodiment does not require user knowledge of specific data items (e.g., clicking a mouse on the specific data item as opposed to having the data item transferred automatically) in order for triggering and transfer to occur. The embodiment places the agency of the process primarily in the computational system, rather than completely in the hands of the human user as in the prior art.

A further aspect differs from the work of O'Hare, G. M. P. and Duffy, B. R., “Agent Chameleons: Migration and Mutation within and between Real and Virtual Spaces.” in The Society for the Study of Artificial Intelligence and the Simulation of Behavior (AISB 02), (London, England, 2002), in which computational agents migrate from one device to another without graphical representation of the transfer and, thus, there is no need to create a continuous (e.g., left to right movement in the real world is reflected by left to right movement on the graphical displays, as in the above example) graphical space among multiple devices. The further aspect of the present invention differs from that work in that an embodiment creates the appearance of a continuous graphical space across multiple collocated devices.

An aspect of the present invention may contribute to an illusion for the users that the computational agents move through the same physical space as the users. In addition, detecting people with a webcam enables the characters to prepare (e.g., moving about on the screen that places them in a position consistent with the real-world positions, for example, of two of the system devices) for the transfer before it actually happens; detecting people with the webcam creates a more engaging experience and encourages the users to bring the mobile device to the correct position for transfer; detecting relative position and orientation with an IrDA (Infrared Data Association) sensor enables two devices to transfer only when they are in the proper configuration; using a device with accelerometers in it creates a more analogous connection between the real world and the virtual world, thereby making it easier for people to understand that animated agents will transfer among collocated devices; using an automatic sensing technology such as IrDA reduces the cognitive effort that people need to take so that it is no greater than interacting with the real world; timing the animations correctly between two devices causes the animation to appear to be continuous between the devices; and providing sound can aid the development of new applications of the system by providing debugging as sound may operate despite a programming error that defeats perceptible animation.

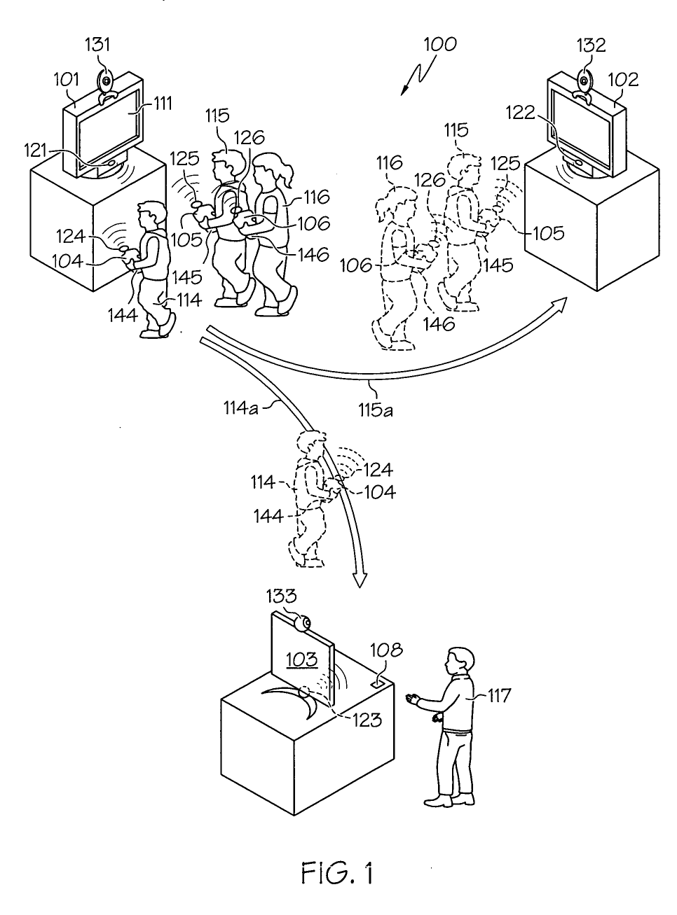

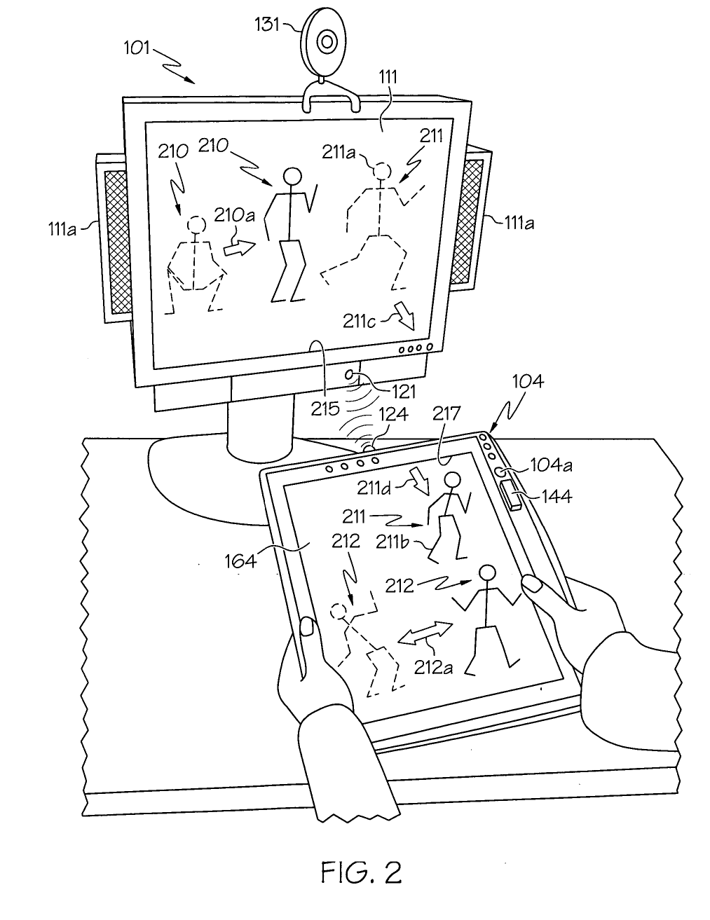

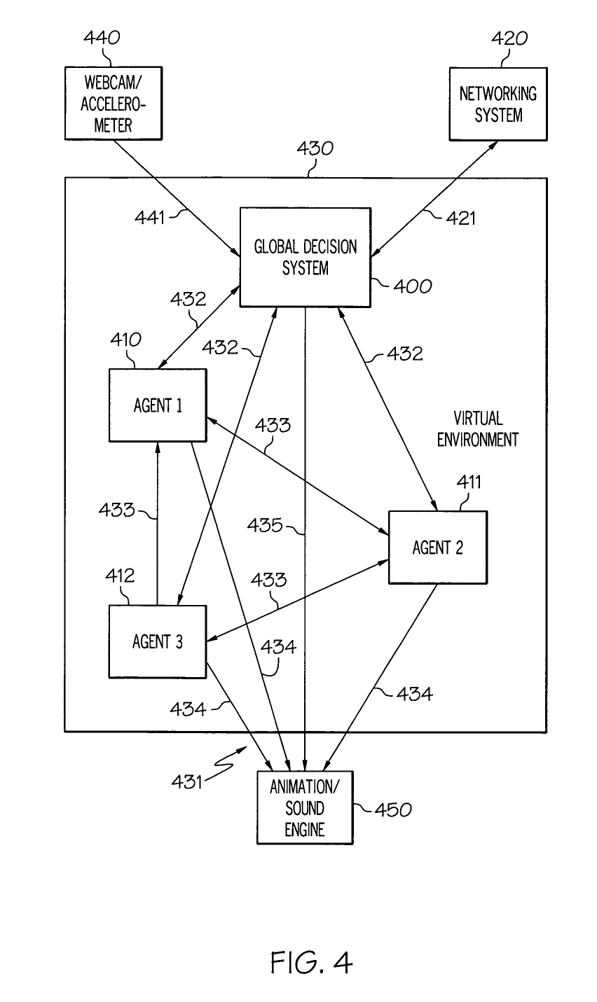

FIG. 1 illustrates an exemplary multi-device, multimedia information system 100 in accordance with one embodiment of the present invention. In the particular example used to illustrate one embodiment of the present invention, system 100 may include three computer workstations (computational devices) 101, 102, and 103, and three tablet PCs (computational devices) 104, 105, 106. The workstations 101-103 may represent “virtual islands” populated by one or more embodied mobile agents—graphically animated, autonomous or semiautonomous software systems (including software being executed on a processor) that can migrate seamlessly from one computational device to another (e.g. agents 410-412, see FIG. 4) represented in the illustrative example by animated humanoid characters 210, 211, and 212 (see FIG. 2).

Depending on the game or application, characters 210-212 could vary from each other and need not be limited to animal or human types. In an ecology simulation, for example, some characters may represent an animal or plant species, while other characters might represent a type of soil or rainfall condition. For the factory example, the characters might be machine operator manuals. The example used to illustrate one embodiment should not be taken as limiting.

The tablet PCs 104-106 may represent “virtual rafts” that game participants or system users 114, 115, and 116 can carry between the islands 101, 102, 103—as shown in FIG. 1 by the dashed outline representation of users 114-116 and indicated by movement arrows 114a and 115a—in order, for example, to transport the agents/characters from island to island so as to further an object of the game or application. For example, users 115, 116 are shown carrying tablet PC's (rafts) 105, 106 from island 101 to island 102, and user 114 is shown carrying raft 104 from island 101 to island 103 in FIG. 1.

In addition, system 100 may provide an input device 108 , such as a pushbutton, connected to island 103, for example, as shown in FIG. 1, to enable another system user 117 in addition to users 114-116 to also interact with system 100, e.g., to participate in an application of the system 100, such as a game.

When a raft (e.g., one of tablet PCs 104, 105, 106) is brought (e.g., carried) within some pre-determined proximity and orientation to one of the islands (e.g., one of workstations 101, 102, 103), an autonomous computational agent—also referred to as embodied mobile agent or, more briefly, agent—can jump (i.e., autonomously transfer) onto it, as illustrated in FIG. 2 by character 211 moving—such as from position 211a to position 211b—and as indicated by movement arrows 211c and 211d.

In the example illustrated in FIG. 2, detectors 121 and 124 may detect each other when the device 104 is brought within some pre-determined proximity (e.g., 1 meter) of device 101 and some pre-determined relative orientation—for example, that the detectors are within some pre-determined angle of pointing directly at each other (e.g., 30 degrees). Then the two devices 101, 104 may supply each other and themselves with information about their relative orientation based on physical assumptions about the physical relationship of each detector 121, 124, respectively, to each device 101, 104.

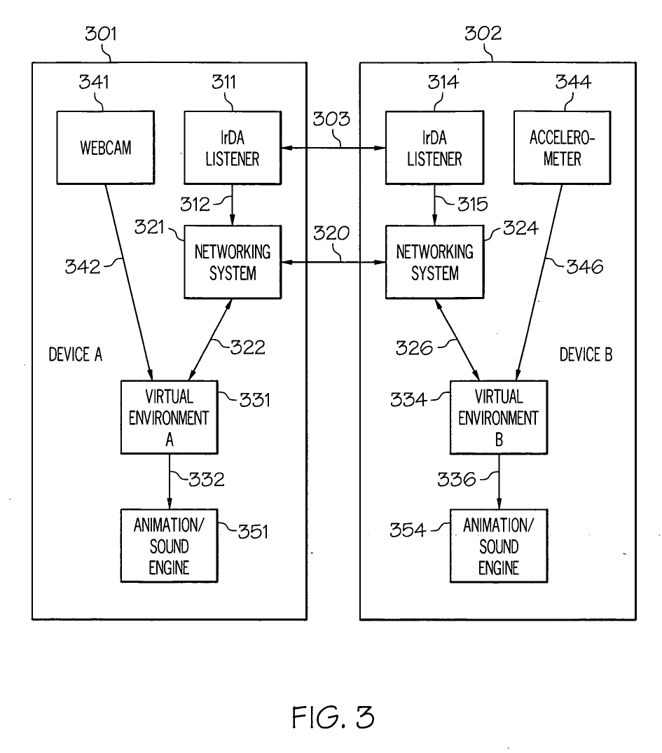

For example, the island 101 detectors 121 may be in front of the island 101 as shown, so that when the island detector 121 detects raft 104, the island 101 “knows” (may assume) that the raft 104 is in front of the island 101 (e.g., in the direction of border 215 of display 111) and that raft 104 may be assumed to be oriented (for IrDA detection to occur in this example) with raft detector 124 pointed toward the island. Likewise, raft 104 may “know” that it is oriented so that island 101 is in front of the raft 104 (e.g., in the direction of border 217 of display 164). The information by which each device “knows” about relative position and orientation of itself and other devices in system 100 may be stored by each device's virtual environment, for example, virtual environment 331 of device 301, shown in FIG. 3, which may correspond to device 101 and virtual environment 334 of device 302 which may correspond to device 104 and may be processed, for example, by a global decision system 400 of each device's virtual environment 430 as well as agents 410-412 (see FIG. 4) executing within the virtual environment 430.

Thus, a continuous graphical space may be created among multiple devices, and in this example in particular, across devices 101, 104 for the animations of character 211 on devices 101, 104 so that character 211 appears to cross over border 215 and then over border 217 consistently, both spatially and temporally, with the relative positions and orientations of devices 101, 104, as also indicated by movement arrows 211c and 211d.

When the participant, e.g., user 114, then, for example, carries that raft, e.g., tablet PC 104, to a different island, e.g., workstation 103, the agent (e.g. agent 411 represented by character 211) can jump from the raft 104 onto the island 103, transferring the information content from island 101 to island 103. The transferred information content, thus, may include an embodied mobile agent 411 (see FIG. 4) and the character (e.g., character 211) which may represent the particular embodied mobile agent 411 transferred.

In addition, an agent can jump from one raft to another. For example, in FIG. 1, if rafts 105, 106 were to be brought into proximity by users 115, 116 an agent could jump from raft 105 to raft 106 or vice versa. Additionally, in system 100, an agent may jump from one island to another if the islands are brought into proximity with each other. In each case a seamless information space across devices may be provided for the agents.

The collocation (e.g., proximity and orientation) of one device (e.g., island 101-103 or raft 104-106) relative to another (e.g., island 101-103 or raft 104-106) required for an agent to be able to transfer from one device to another device in system 100 may be determined (e.g., with regard to maximum distance and range of orientation angles) by the technology used (e.g., infrared, visible light, or sound sensors) for the devices to detect each other. In the example illustrated by system 100, each island workstation 101-103 can have a respective detector 121, 122, and 123; and each raft tablet PC 104-106 can have a respective detector 124, 125, and 126.

For example, the system 100 may use IrDA devices for detectors 121-126 for detecting proximity and orientation of one mobile device (e.g., rafts 104-106) to another device (e.g., either islands 101-103 or rafts 104-106). In an exemplary embodiment, each desktop computer (e.g., islands 101-103) may use an IrDA dongle to detect if a raft 104-106 is within range (e.g., from about 3 meters to adjacent). The tablet PCs (e.g., rafts 104-106) may have built-in IrDA adapters, for example. An acceptable reception range of IrDA is approximately one to three meters and can require the IrDA devices to be within an angle of approximately 30 degrees to each other.

The proximity and the angle requirement of IrDA may be useful for adjusting the proximity detection. By adjusting the angle of the IrDA adapter, it is possible, as would be understood by one of ordinary skill in the art, to tune the effective sensing distance, i.e. the required proximity for the collocation required for an agent to be able to transfer. In addition, because the detector of each device must be within the angle requirement of the other, adjusting the angle may be used to adjust the relative orientation required for the collocation required for an agent to be able to transfer.

Thus, two devices (e.g., devices 101, 104) of system 100 may be said to be collocated when the respective detectors (e.g., detectors 121, 124) detect each other because they must be within some pre-determined proximity and range of orientations to each other in order to detect each other. For example, in the case of IrDA devices 121, 124, the devices 101, 104 may be collocated when IrDA devices 121, 124 establish communication with one another, which may require, for example, IrDA devices 121, 124 to be “pointing” at one another and within a certain distance.

In operation, when the computer, either a desktop island 101-103 or mobile raft 104-106, say device 104, detects the IrDA signal of a nearby device 101-106, say device 101, device 104 may attempt to connect to the other computer device 101 using TCP/IP (Transfer Control Protocol/Internet Protocol) through Wi-Fi (IEEE 802.11) and wired Ethernet. TCP/IP may be chosen over IrDA for sending the actual data because Ethernet can be much faster than infrared, and transmission delays could decrease the graphical and animation continuity of the jump, for example, by affecting the transfer of character 211. The use of TCP/IP allows there to be as many islands and rafts as there are unique IP addresses.

Once a connection (e.g., establishment of IrDA communication between detectors 121 and 124) is made between devices 101 and 104, in this example, the system 100 at device 101 may package up the attributes (e.g. color, gender, unique ID, emotion states) of the character, say character 211, into a single data object and send it through TCP/IP to the other device 104 as illustrated at FIG. 2. The animations and behavior code of the character 211 may be duplicated on each of the different desktops stations 101-103 and mobile devices 104-106. As the animations and the behavior code may be quite large in size, packaging the whole character 211 at device 101 and transferring it to the other device 104 could introduce a time lag during the transfer, thus compromising the seamless nature of the jump indicated at 211c and 211d.

As can be seen, system 100 can enable people to engage physically with embodied mobile agents in several ways. For example, the act of moving the tablet PCs 104-106 between the islands gives people (e.g., users 114-117) a physical connection to the virtual space of system 100 and enables them to control the movements of embodied mobile agents among the islands 101-103, for example, by selectively providing transportation on rafts between the islands for the agents.

Additionally, webcams 131, 132, 133 respectively above each of the virtual islands 101-103, running a simple, as understood by one of ordinary skill in the art, background subtraction algorithm, enable the agents to react to the presence of people (e.g., users 114-117) standing in front of that island (101, 102, or 103 corresponding to 131, 132, and 133, respectively) and respond to their motion.

For example—using island workstation 101 to illustrate—when no one is moving around in front of the display screen 111, a virtual character (e.g., character 210) may take a sitting position, as indicated by the dashed line figure of character 210 to the left, in FIG. 2, on the display screen 111. When the web cam 131 above the virtual island 101 detects motion, the character 210 may stand up and approach the front of the screen 111, as indicated by the rendition of character 210 and movement arrow 210a shown in FIG. 2.

Furthermore, accelerometers 144, 145, and 146, in each tablet PC 104, 105, and 106, respectively, let the agents react to the physical motion of the raft tablets 104, 105, and 106 as people carry them. For example, character 212 may sway back and forth—as indicated by the dashed and solid renditions of character 212 in FIG. 2 and movement arrow 212a—as the tablets are carried between islands 101, 102, and 103. In addition, display 111 and raft 104 may also be capable of rendering sound as part of the display, for example, using speakers 111a and 104a, respectively. The use of sound may enhance the display of the agents' characters (e.g., characters 210-212) and their context in system 100, and may provide a further level of engagement for the users 114-117.

While FIG. 2 illustrates an exemplary operation of system 100, between device 101 and device 104, as it may appear to a user of system 100, FIG. 3 illustrates an exemplary internal logical operation of system 100 as between two, for example, devices A and B, device A represented as device 301, and device B represented as device 302. Referring now to FIG. 3, when two devices, for example, workstation 101 and tablet PC 104 (alternatively, two rafts, e.g., tablet PC 105 and tablet PC 106 could be used to illustrate the example), are brought into a proximity and orientation so that the IrDA ports of detectors 121, 124 are able to see each other, IrDA communication may be established between the two devices, for example, device 301 and device 302 illustrated in FIG. 3. The IrDA ports of detectors 121, 124 may be connected, respectively, to IrDA listeners 311, 314, which may then communicate with each other over IrDA link 303. IrDA listeners 311, 314 may identify and exchange each other's computer name, which may be an identification uniquely corresponding to each device in system 100 and, in particular, devices 301 and 302. The computer name for device 301 may be passed to networking system 324 over connection 315 on device 302, and likewise the computer name for device 302 may be passed to networking system 321 over connection 312 on device 301. Each networking system 321, 324 may, using a lookup table for example, look up the corresponding IP address for the computer name of each device 302, 301, respectively. Using these IP addresses for devices 302, 301, the networking systems 321, 324 on the two devices 301, 302 may make a connection 320 using TCP/IP. The time of inception of the connection 320 may serve as the time stamp that allows animations to appear to be synchronized on both devices 301, 302.

Data exchanged through the connection 320 may affect the virtual environment 331, 334 of each device 301, 302. For example, data from device 302 may be passed to virtual environment 331 via connection 322 and, similarly, data from device 301 may be passed to virtual environment 334 via connection 326. The data received by each virtual environment 331, 334 may be included in a basis for autonomous decision causing each device 301, 302 to decide which actions, if any, the animated entities—represented, for example, by characters 210-212—should perform.

The webcam 341, accelerometer 344 or other real-world physical sensing devices can also affect the virtual environment 331, 334 of each device 301, 302. Data from webcam 341 may be passed to virtual environment 331 via connection 342 and, similarly, data from accelerometer 344 may be passed to virtual environment 334 via connection 346. The data received by each virtual environment 331, 334 from such physical sensing devices, such as webcam 341 and accelerometer 344, may also be included in a basis for autonomous decision causing each device 301, 302 to decide which actions, if any, the animated entities, or embodied mobile agents—represented, for example, by characters 210-212—should perform. For example, when the webcam 341 (corresponding in this example, to webcam 131 of device 101 in FIG. 1) detects the presence of people (e.g., system users 104-106) in front of the monitor (e.g., display screen 111), the virtual environment 331 may cause characters 210, 211 to walk toward the front of the screen 111, putting them in a better position—with regard to realism for the animation—for jumping to another device, e.g., device 302 (corresponding in this example to device 104 in FIGS. 1 and 2).

System 100 may make autonomous decisions regarding the transfer of information content from one device, say device 301, to another, say device 302, without further input (e.g., by movement of rafts or use of input device 108) from any user at the time the decision is made. An autonomous decision may be made, for example, jointly between the two virtual environments 331, 334 based on the data exchanged between the devices 301, 302, the data from physical sensing devices, such as webcam 341 and accelerometer 344, and the internal states of the agents residing on each device, which may include a dependence upon, for example, character attributes (e.g. color, gender, unique ID, emotion states) of each agent. Once a decision has been determined as to what actions the characters (e.g., characters 210-212) should take, each virtual environment 331, 334 then informs the respective animation/sound engine 351, 354 via communications 332, 336 respectively. Each virtual environment 331, 334 may also inform the other device 302, 301, respectively, via the networking system connection 320 if the action will prompt a change on the other device 302, 301, respectively.

The two animation/sound engines may then run different animations and sounds, synchronized, for example, using the time stamp provided by inception of network connection 320, so that an animated entity (e.g., the character 211a in FIG. 2) on Device A (e.g., device 101/301) appears to move toward device 302 Device B (e.g., device 104/302), and then an identical entity (e.g., the character 211b in FIG. 2) may appear on Device B and move away from Device A, giving the appearance of a single continuous animation across the two devices A and B.

Referring now to FIG. 4, virtual environment 430 may be identical with either of virtual environments 331, 334; webcam/accelerometer 440 may be identical with either of webcam 341, accelerometer 344, or other physical sensing device; and may communicate with virtual environment 430 via connection 441, similar to connection 342 or 346; networking system 420 may be identical with networking system 321 or 324 and may communicate with virtual environment 430 via connection 421, similar to connection 322 or 326; and communication 431 with animation/sound engine 450, which may include communications between the sound/animation engine 450 and both a global decision system 400 and agents (e.g., agents 410, 411, and 412) may be identical with communication 332 between virtual environment 331 and animation/sound engine 351 or communication 336 between virtual environment 334 and animation/sound engine 354.

The global decision system 400, which may be an executing process on any computational device (e.g., device 101, of system 100), may keep track, as would be understood by a person of ordinary skill in the art, of the presence of other virtual environments (e.g., distinct from virtual environment 430), which agent (e.g. agents 410, 411, 412, also referred to as information content) is allowed to transfer, where the graphical starting position is for transfers (e.g., where on a display screen such as display screen 111) and other attributes of both virtual environment 430 and adjacent virtual environments (e.g., those that have been brought within a proximity of virtual environment 430 so that communication with virtual environment 430 could be established).

Global decision system 400 may also keep track of a number of other items that may affect decisions to transfer information content and affect the animations provided. For example, global decision system 400 may receive communication via connection 441 between physical sensing devices 440 and virtual environment 430 that may affect characteristics (e.g. position) in its computational model of other (e.g., distinct from virtual environment 430) virtual environments. Also, for example, global decision system 400 may communicate via network connection 421 between networking system 420 and virtual environment 430 in a way that may affect decisions to transfer information content and affect the animations. For example, a communication from the network 420 to virtual environment 430 may notify the virtual environment 430 of the presence of the other virtual environment (e.g., distinct from virtual environment 430) when detected (e.g., via IrDA); a communication from the network 420 to virtual environment 430 may create a new agent when appropriate, for example, when a transfer of information content requires creation on the device being transferred to, as described above; a communication from virtual environment 430 to the network 420 may send a query regarding whether a jump (transfer of information content) is possible; and a communication from virtual environment 430 to the network 420 may send an agent (transfer information content) if circumstances are right, e.g., if a joint autonomous decision has been made to transfer the agent, as described above.

Each agent 410, 411, 412 may have its own decision system that chooses its behavior. Each agent 410, 411, 412 may also store its own internal state. An agent, such as agent 410, may decide whether or not it should or can transfer based on its internal state and information about adjacent virtual environments (e.g., those that have been brought within a proximity of virtual environment 430 so that communication with virtual environment 430 could be established) received from the global decision system 400. If agent 410 decides to transfer, it may send communication 432 to the global decision system 400 to initiate the cross-device transfer. Agents 410, 411, 412 may interact with each other via communication 433 in ways that are specific to a particular implementation. For example, if the agents 410, 411, 412 are represented by humanoid FIGS. 210-212, as in the illustrative example, any two agents may need to ensure that they do not appear to occupy the same space in a graphic representation.

Agents 410, 411, 412 and the global decision system 400 may also communicate with animation/sound engine 450. For example, agents 410, 411, 412 may, via communication 434, tell the animation/sound engine 450 where they are (e.g., which virtual environment, identified by the computer name) and what they are doing (e.g., jumping, staying put) so that the animation engine 450 can display it to the audience, e.g., system users 114-117. Also, for example, the global decision system 400 may cause the animation/sound engine 450, via communication 435, to display various characteristics that reflect the presence or characteristics of adjacent virtual environments (e.g., those that have been brought within proximity of virtual environment 430 so that communication with virtual environment 430 could be established).

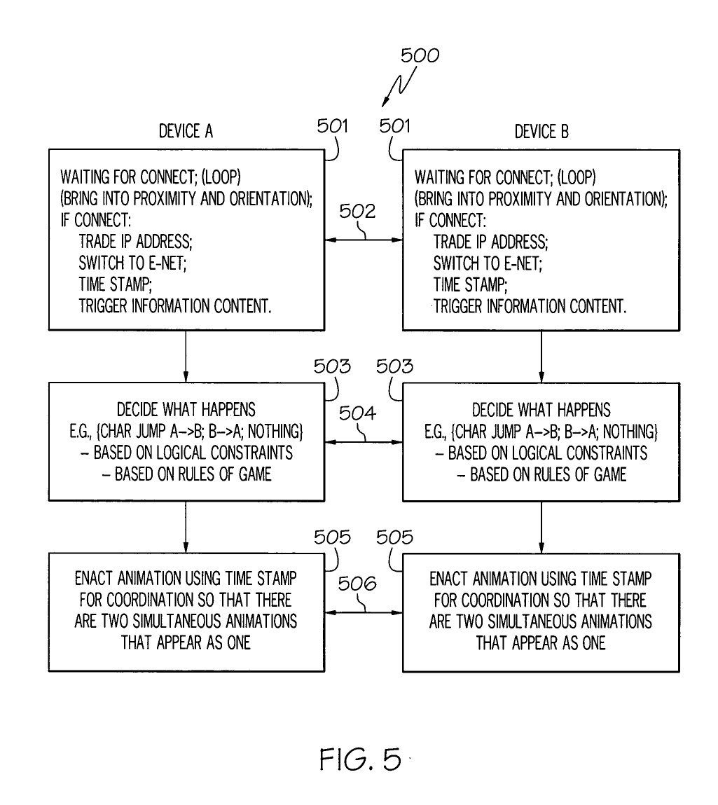

FIG. 5 illustrates method 500 for automatic data transfer between computational devices. Method may include a step 501 that comprises two devices of system 100 being collocated with each other. For example, both raft 104 (device A in FIG. 5) and island 101 (device B in FIG. 5) may be waiting for a connect, e.g., executing a loop, as indicated in FIG. 5, in which IrDA infrared detectors on each device A and B are listening for the presence of another detector on another device. For example, if raft 104 (device A in FIG. 5) is brought within infrared range and oriented toward island 101 (device B in FIG. 5) so that the IrDA listeners of each device A and B can communicate (indicated as proximity and orientation in step 501 of FIG. 5) then the condition <if connect> indicated in step 501 may be satisfied and the further operations indicated at step 501 may be carried out. For example, each device A and B may exchange its IP address with the other as indicated by communication arrow 502. Then each device A and B may switch to Ethernet communication with the other using the IP addresses exchanged, also indicated by communication arrow 502. The inception of Ethernet communication may provide a time stamp for synchronizing the devices A and B, so that, for example, animations can be coordinated to appear as continuous across the devices A and B. Then, information content may be triggered. For example, data may be exchanged between devices A and B that may affect the processing carried out by agents—such as agents 410, 411, 412—and cause, for example, an agent, such as agent 411, to transfer from device B to device A. The transfer of an agent may include transfer of the agent along with a character representing that agent, such as character 211 representing agent 411.

Method 500 may include a step 503 in which each of device A and B executes processing to decide what interaction should happen between devices A and B. The processing can lead to a mutual autonomous decision, for example, as to whether a character—such as character 211—should jump from device A to device B, should jump from device B to device A, or no jump should occur. Insomuch as character 211 may represent, for example, agent 411, the same decision may also include whether agent 411 is to transfer or not, and in which direction. The decision may be based on logical constraints. For example, if character 211/agent 411 is on device B and not on device A, then character 211/agent 411 cannot jump from device A to device B. The decision may also be based on other considerations, such as rules of a game or application being implemented by system 100. For example, if the game has a rule that only one character may occupy a raft 104 (device A) at a time, and character 212 already occupies the raft 104, as shown in FIG. 2, then character 211/agent 411 cannot jump from device B to device A. Logical and other constraints affecting both devices A and B may be communicated back and forth as indicated by communication arrow 504.

Method 500 may include a step 505 in which each device A and B displays an animation that is coordinated with the animation on the other device so that the two concurrent animations appear as one continuous animation across the two devices A and B. For example, the devices A and B can be synchronized with the time stamp provided at step 501 so that, for example, character 211 will appear to have left device B before arriving on device A so as not to appear in two places at once, for example, if the animations were out of synch so that character 211 appeared to arrive at device A before having completely left device B. Agent 411 may be transferred concurrently with the representation of the transfer, which may be represented, for example, by animation of character 211 (representing agent 411) jumping from device B to device A, as indicated by communication arrow 506.

It should be understood, of course, that the foregoing relates to exemplary embodiments of the invention and that modifications may be made without departing from the spirit and scope of the invention as set forth in the following claims.

We claim:

1. A multimedia information system comprising:
a first computational device; and
a second computational device, wherein an information content is automatically transferred between said first computational device and said second computational device when said first computational device and said second computational device are collocated.

2. The multimedia information system of claim 1, wherein:
said information content includes an agent; and
said agent performs a process included in an autonomous decision whether to automatically transfer said information content.

3. The multimedia information system of claim 1, further comprising:
a global decision system wherein said global decision system performs a process included in an autonomous decision whether to automatically transfer said information content.

4. The multimedia information system of claim 1, further comprising:
a first detector on said first computational device; and
a second detector on said second computational device, wherein said first computational device and said second computational device are collocated when said first detector and said second detector communicate with each other.

5. The multimedia information system of claim 1, further comprising:
a first animation engine included in said first computational device that provides a first animation when said information content is automatically transferred; and
a second animation engine included in said second computational device that provides a second animation when said information content is automatically transferred, wherein said first animation and said second animation are synchronized to appear as a single animation across both said first computational device and said second computational device.

6. A multi-device system comprising:
a first device having a first detector;
a second device having a second detector, wherein:
said second detector detects a first presence and first orientation of said first device; and
said first detector detects a second presence and second orientation of said second device; and
an agent that receives communications from said first detector and said second detector and decides whether or not to transfer between said first device and said second device on a basis that includes said communications from said first detector and said second detector.

7. The multi-device system of claim 6, further comprising:
a first global decision system of said first device;
a second global decision system of said device, wherein:
said first global decision system communicates with said second global decision system and with said agent;
said second global decision system communicates with said first global decision system and with said agent; and
said first global decision system and said second global decision system initiate an exchange of information content when said agent decides to transfer.

8. The multi-device system of claim 7, wherein said agent decides to transfer based on an internal state of said agent and a first virtual environment information received from said first global decision system and a second virtual environment information received from said second global decision system.

9. The multi-device system of claim 7, wherein said information content includes said agent.

10. The multi-device system of claim 7, further comprising:
a first animation engine included in said first device that:
communicates with said first global decision system and with said agent;
displays a first animation using a first information from said first global decision system and a second information from said agent; and
a second animation engine included in said second device that:
communicates with said second global decision system and with said agent; and
displays a second animation using a third information from said first global decision system and the second information from said agent, wherein said first animation and said second animation are synchronized as a coordinated animation across said first device and said second device.

11. A system comprising:
at least two devices each having a networking system;
an embodied mobile agent executing on at least one of the devices, wherein said at least one device comprises:
a global decision system wherein said global decision system:
communicates with an adjacent virtual environment of a collocated device via a networking system of said at least one device;
communicates with the embodied mobile agent; and
causes an animation engine to display a characteristic that reflects a presence and characteristic of the adjacent virtual environment; and wherein
the agent communicates with the animation engine so that the animation engine display reflects where the agent is and what the agent is doing.

12. The system of claim 11, wherein:
said device further includes a sensor that provides a physical characteristic information of the device's environment to said global decision system;
said global decision system provides said physical characteristic information to the agent;
said global decision system causes said animation engine to display a characteristic that reflects said physical characteristic information; and
said agent communicates with the animation engine so that the animation engine display reflects a reaction of said agent to said physical characteristic information.

13. The system of claim 12, wherein:
the sensor is a webcam; and
the physical characteristic information reflects a presence or absence of a user within a predefined proximity of the webcam.

14. The system of claim 12, wherein:
the sensor is an accelerometer; and
the physical characteristic information reflects a change in orientation of the device.

15. The system of claim 12, wherein:
the sensor is an infrared communication device; and
the physical characteristic information reflects a presence or absence of an adjacent device within a predefined proximity of the infrared communication device.

16. A multimedia information system comprising:
a first computational device; and
a second computational device including:
a detector that detects a presence and orientation of said first computational device;
an embodied mobile agent wherein:
said embodied mobile agent receives information of said presence and orientation of said first computational device;
said embodied mobile agent modifies and communicates an information content; and
said information content is transferred between said second computational device and said first computational device in accordance with a decision made by said embodied mobile agent that includes utilizing said information of said presence and orientation of said first computational device.

17. A computational system comprising:
a first computational device;
a virtual character residing on said first computational device; and
a second computational device, wherein:
said virtual character automatically transfers from said first computational device to said second computational device when said second computational device is collocated with said first computational device.

18. The computational system of claim 17, wherein:
said virtual character automatically either transfers or else does not transfer according to a state of said first computational device, a state of said second computational device, and a physical aspect of said first computational device being collocated with said second computational device.

19. The computational system of claim 17, wherein:
said second computational device is collocated with said first computational device when a first infrared communication device of said first computational device is brought into communication with a second infrared communication device of said second computational device.

20. The computational system of claim 17, further comprising:
a first animation on said first computational device that reflects said virtual character transferring from said first computational device; and
a second animation on said second computational device that reflects said virtual character transferring to said second computational device, wherein said first animation and said second animation are automatically synchronized in conjunction with said automatic transfer of said virtual character so that said first animation and said second animation appear as one continuous animation.

21. A method for automatic data transfer between computational devices, comprising steps of:
collocating at least two distinct computational devices;
making an autonomous decision for an interaction to occur between the two collocated computational devices; and
performing the interaction automatically between the two collocated computational devices.

22. The method of claim 21, wherein said step of collocating further comprises:
positioning at least one of said two computational devices so that an infrared communication system establishes communication between the two computational devices.

23. The method of claim 21, wherein said step of collocating further comprises:
positioning at least one of said two computational devices so that said two computational devices detect each other's presence using detectors;
establishing communication between said two computational devices via said detectors; and
switching over communication between said two computational devices from said detectors to a networking system.

24. The method of claim 21, wherein said step of autonomous decision making further comprises:
an agent residing on one of said two collocated computational devices making said autonomous decision, wherein said agent processes:
a first information received from a first global decision system of a first of said two collocated computational devices,
a second information received from a second global decision system of a second of said two collocated computational devices, and
said agent's internal state.

25. The method of claim 21, wherein, in said step of automatically performing, the interaction includes:
transfer of an information content between said two collocated computational devices.

26. The method of claim 21, wherein, in said step of automatically performing, the interaction includes:
two synchronized animations, a first animation on a first of said two collocated computational devices and a second animation on a second of said two collocated computational devices, wherein said two animations appear as one continuous animation across said two collocated computational devices.

27. A method for multi-device computing, comprising the steps of:
displaying a first animation on a first computational device;
bringing a second computational device into a physical collocation with said first computational device;
displaying a second animation on said second computational device, wherein:
said second animation is synchronized with said first animation; and
said second animation is spatially consistent with said first animation.

28. The method of claim 27, wherein said first animation and said second animation are displayed with graphical continuity between the first device and the second device according to the relative orientation of the first device and the second device.

29. The method of claim 27, wherein said first animation and said second animation utilize the physical relationship between the first computational device and the second computational device to provide a seamless information space between the two devices.

30. The method of claim 27, further comprising the step of:
an autonomous computational agent moving between the first computational device and the second computational device in a way that utilizes the proximity and relative orientation between the devices.

31. A method of creating a continuous graphical space, comprising:
detecting a proximity and relative orientation between at least two computational devices;
communicating information of said proximity and relative orientation between said at least two computational devices; and
processing said information in each of said at least two computational devices to create said continuous graphical space.

32. The method of claim 31, further comprising steps of:
communicating a time stamp between said two computational devices; and
using said time stamp to synchronize a cross-device animation on said two computational devices.

33. The method of claim 31, further comprising steps of:
performing a cross-device animation comprising:
performing a first animation on a first of said two computational devices;
performing a second animation on a second of said two computational devices; and
using said proximity and relative orientation information to give said cross-device animation the appearance of continuity between the first animation and the second animation so that the two animations appear physically as a single animation occurring across the two computational devices.

34. The method of claim 31, further comprising the step of:
performing a cross-device animation on said at least two computational devices, wherein:
a first device is in the direction of a second border of a second display of a second device and a second device is in the direction of a first border of a first display of a first device; and
said information is used so that a character appears to cross over the first border from the first device and then over the second border to the second device so that said cross-device animation is consistent with the relative positions and orientations of the two devices.
